(19) United States
(12) Patent Application Publication
(10) Pub. No.: US 2015/0081538 A1
(43) Pub. Date: Mar. 19, 2015

(54) SYSTEMS AND METHODS FOR PROVIDING SECURE DIGITAL IDENTIFICATION

(71) Applicant: TORO DEVELOPMENT LIMITED, Taipei City (TW)

(72) Inventors: Laurent Renard, Hong Kong (HK); Gregory Puente-Castan, Hong Kong (HK)

(73) Assignee: TORO DEVELOPMENT LIMITED, Taipei City (TW)

(21) Appl. No.: 14/026,330

(22) Filed: Sep. 13, 2013

(51) Int. Cl. G06Q 20/40; G06Q 20/36; G06Q 20/32; H04B 5/00

(52) U.S. Cl. CPC G06Q 20/4014; H04B 5/0031; G06Q 20/36; G06Q 20/3278
USPC 705/41

(57) ABSTRACT

Systems and methods for providing secure digital identification are described. The system comprises a mobile digital wallet installed on a NFC-enabled mobile electronic device. The mobile digital wallet is configured to receive a service provider request for personal ID information to enable the service provider to provide a service. The personal ID information is stored both in a secure element and at a secure wallet server. The system can determine a minimum-required-subset of the personal ID information necessary to satisfy the requested personal ID information and analyze whether to provide the minimum-required-subset from the secure element via the NFC transceiver or from the secure wallet server via the wireless network. The system can then cause the minimum-required-subset of the set of personal ID information to be provided to the service provider in response to the analyzing step. A method of implementing the system is also described.

### FIELD OF THE INVENTION

The present invention relates to a secure digital identification system and method, and more particularly, to a mobile digital wallet identification system and method for Near-Field Communication (NFC) services and a mobile electronic device thereof.

### BACKGROUND OF THE INVENTION

With the proliferation of technology and the rapid integration of nearly every commercial industry, financial institution, educational organization, and government agency with the World Wide Web, it has become increasingly difficult for individuals to protect their identities. Identity theft is rampant, and yet individuals are asked to provide personal identification information to service providers or to security personnel to gain access to particular locations, without any guarantee of the security of their information. In fact, individuals are often requested to provide more personal information than is actually required to verify who they are, both over the internet and in everyday transactions. Conversely, service providers, vendors, security personnel, etc., would like as much assurance as possible that individuals are who they claim to be.

Presently there are no suitable options for harnessing technology to provide “bulletproof” identification, while protecting the identity and privacy of those providing their personal information.

### SUMMARY OF THE INVENTION

Technologies are presented here in support of systems and methods of providing secure digital identification.

According to a broad aspect of the invention, NFC-enabled systems and methods receive a request at user's mobile device for the user to provide personal identification (ID) information to a service provider. A subset of the user's personal ID information sufficient to satisfy the request is determined and provided to the service provider, either via a NFC connection or via a secure server over a network.

According to a more particular aspect of the invention, a method for providing a mobile digital wallet identification system for use with a mobile electronic device having a processor, memory, code in the memory for implementing in the processor a mobile digital wallet, and an NFC transceiver is provided. In accordance with the method, the mobile electronic device is operatively coupled to a secure element and is in wireless communication with a secure wallet server over at least one wireless network.

The mobile digital wallet receives a service provider request which requests access to a subset of a set of personal ID information to enable the service provider to provide a service, the set of personal ID information being stored both in the secure element and at the secure wallet server. The mobile digital wallet then determines, using code executing in the processor, a minimum-required-subset of the set of personal ID information necessary to satisfy the access request to the requested subset of the set of personal ID information. The mobile digital wallet then analyzes, using code executing in the processor, whether to provide the minimum-required-subset of the personal ID information from the secure element via the NFC transceiver or from the secure wallet server via the wireless network. The method concludes with causing the minimum-required-subset of the set of personal ID information to be provided to the service provider in response to the analyzing step having concluded to provide the minimum-required-subset of the set of personal ID information.

Methods in accordance with more particular aspects of the invention can include further steps. For instance, the method can further include initializing a wireless download of at least one of a widget and a secure application over the wireless network from a server of the service provider subsequent to the service provider receiving the minimum-required-subset of the set of personal ID information as a result of the causing step.

In further embodiments, the method can further include, prior to the causing step, acquiring by the mobile digital wallet an account identifier and an access identifier from the user, the account identifier being associated with an account comprising the set of personal ID information and the access identifier indicating a right of the user to access the account. In some embodiments, the access identifier is a numeric code, an alphabetical code, an alphanumeric code, and/or a gesture, and the access identifier is acquired via a User Interface (UI) of the mobile electronic device and detected by the mobile digital wallet. In some embodiments, the service provider request is an initiator request generated by a service provider-NFC transceiver, and the mobile electronic device is a target of the initiator request. In alternative embodiments, the service provider request is a response generated by a target service provider-NFC transceiver in response to an initiator request sent from the NFC transceiver of the mobile electronic device. The method can further include activating the NFC transceiver for radio frequency (RF) communication prior to the receiving step, enabling the receiving of the service provider request.

In yet further detailed embodiments of the invention, the receiving step can further comprise receiving at the mobile digital wallet an electronic notification comprising the service provider request, which can be one of a text message, multimedia message, instant message, and e-mail, notifying the user of a desire of the service provider to access the subset of the set of personal ID information. In accordance with aspects of the invention, the set of personal ID information includes at least one of the user's government-issued ID information, identifying image, biometric data, secure login credentials, membership information, address, and contact information.

According to yet another broad aspect of the invention, a system includes a mobile electronic device having a processor, memory, code in the memory which, when executed in the processor, implements a mobile digital wallet, and an NFC transceiver. The system further includes a secure element, the mobile electronic device being operatively coupled to the secure element; and a secure wallet server, the mobile electronic device being in wireless communication with the secure wallet server over at least one wireless network.

In a more particular aspect, the system executes the code in the processor for implementing the mobile digital wallet on the mobile electronic device which, when executed, configures the processor to: receive at the mobile digital wallet a service provider request which requests access to a subset of a set of personal ID information to enable the service provider to provide a service, the set of personal ID information being stored both in the secure element and at the secure wallet server; determine by the mobile digital wallet, using code executing in the processor, a minimum-required-subset of the set of personal ID information necessary to satisfy the access request to the requested subset of the set of personal ID information; analyze, by the mobile digital wallet, using code executing in the processor, whether to provide the minimum-required-subset of the personal ID information from the secure element via the NFC transceiver or from the secure wallet server via the wireless network; and cause the minimum-required-subset of the set of personal ID information to be provided to the service provider in response to the analyzing step having concluded to provide the minimum-required-subset of the set of personal ID information.

These and other aspects, features and advantages of systems and method will be understood with reference to the following description of certain embodiments of the invention.

### BRIEF DESCRIPTION OF THE DRAWINGS

FIG. 1 is a high-level diagram illustrating an exemplary configuration of a system for providing secure digital identification according to embodiments of the invention;

FIG. 2 is a high-level flow diagram illustrating elements of a method for providing secure digital identification according to embodiments of the invention;

FIG. 3A and FIG. 3B are flow diagrams illustrating detailed elements of the method of FIG. 2 according to embodiments of the invention;

FIG. 4 is a high-level diagram illustrating a further exemplary configuration of a system for providing secure digital identification according to embodiments of the invention; and

FIG. 5 is a high-level flow diagram illustrating elements of a further method for providing secure digital identification according to embodiments of the invention.

### DETAILED DESCRIPTION OF EMBODIMENTS OF THE INVENTION

By way of overview and introduction, various systems and methods are described herein that facilitate providing secure digital identification by employing Near Field Communication (NFC) services to provide access to personal identification (ID) information stored in a secure element on a user's mobile electronic device (“MED” or “mobile device”) and on a secure server accessible over a wireless network. An electronic document (e-document) is compiled containing a user's most private and sensitive personal ID data (e.g., social security number, passport number, ID photo, biometric data, home address, drivers license, etc.), and the document is stored both in the secure element of the user's mobile device and on a secure server. An application installed on the user's mobile device manages access to the data. When a request for personal ID information is made, for example, by a service provider (SP), a secure NFC connection is created. The application then determines the minimum required set of data needed for the specific purpose of the request, and analyses whether to provide the data from the secure element over the NFC connection or from the secure server, depending on the nature of the request and the nature of the situation. The data can then be transmitted to the service provider via the selected path.

NFC is a short-range wireless connectivity technology that evolved from a combination of existing contactless identification and interconnection technologies. Products with built-in NFC simplify the way consumer devices interact with one another, helping people speed connections, receive and share information and make fast and secure payments.

Operating at a center frequency of 13.56 MHz and transferring data at up to 424 Kbits/second, NFC provides intuitive, simple, and safe communication between electronic devices. NFC is both a “read” and “write” technology. Communication between two NFC-compatible devices occurs when they are brought within four centimeters of one another: a simple wave or touch can establish an NFC connection, which is then compatible with other known wireless technologies such as Bluetooth or Wi-Fi for continuing the communication session initiated using NFC. The underlying layers of NFC technology follow universally implemented ISO, ECMA, and ETSI standards. Because the transmission range is so short, NFC-enabled transactions are inherently secure. Also, physical proximity of the device to the reader gives users the reassurance of being in control of the process.

NFC can be used with a variety of devices, from mobile phones that enable payment or transfer information, to digital cameras that send their photos to a TV set with just a touch.

An NFC connection always includes at least two devices, an initiator and a target. The initiator is the device that starts the NFC connection, by generating a radio frequency (RF) field that modulates toward a target device in the form of a request for connection. The target then responds to the initiator request and communication begins.

An NFC connection can be established in two modes, Active communication mode and Passive communication mode, depending on the target device. While the initiator is always a powered device capable of generating an RF field, the target may or may not be capable of generating its own RF field. In Active mode, both the initiator and target are powered and capable of generating their own RF field to communicate. The initiator starts the communication, and the target responds by modulating its own RF field toward the initiator. In Passive mode, the initiator starts the communication, and the target responds by modulating the initiator's RF field back to the initiator. By employing one of these modes of NFC, a secure connection between a user and a service provider can be established.

In accordance with embodiments of the invention, a service provider may be any individual, group, corporation, agency, etc. that provides a service or product to the user. For example, a service provider can be a retail or wholesale vendor, a professional services firm, a healthcare professional network, a financial institution, an educational organization, a transportation company, or a government agency. It should be noted that, while the systems and methods are described herein primarily as they relate to a transaction between a user and a service provider, transactions between a user and other entities can also be performed using the systems and methods. As such, a user may use the systems and methods described herein in order to securely provide a digital form of the user's identification in situations in which identification of the user is required, but in which a service or product is not necessarily being provided. For example, the systems and methods described herein can be used for security purposes to enable entry into otherwise restricted areas (e.g., at an airport, or to access a nightclub), or simply to identify one's self, such as when requested by a police officer. Therefore, the term ‘service provider’ as used herein should not be considered limiting except inasmuch as it refers to an individual or entity requesting identification from a user.

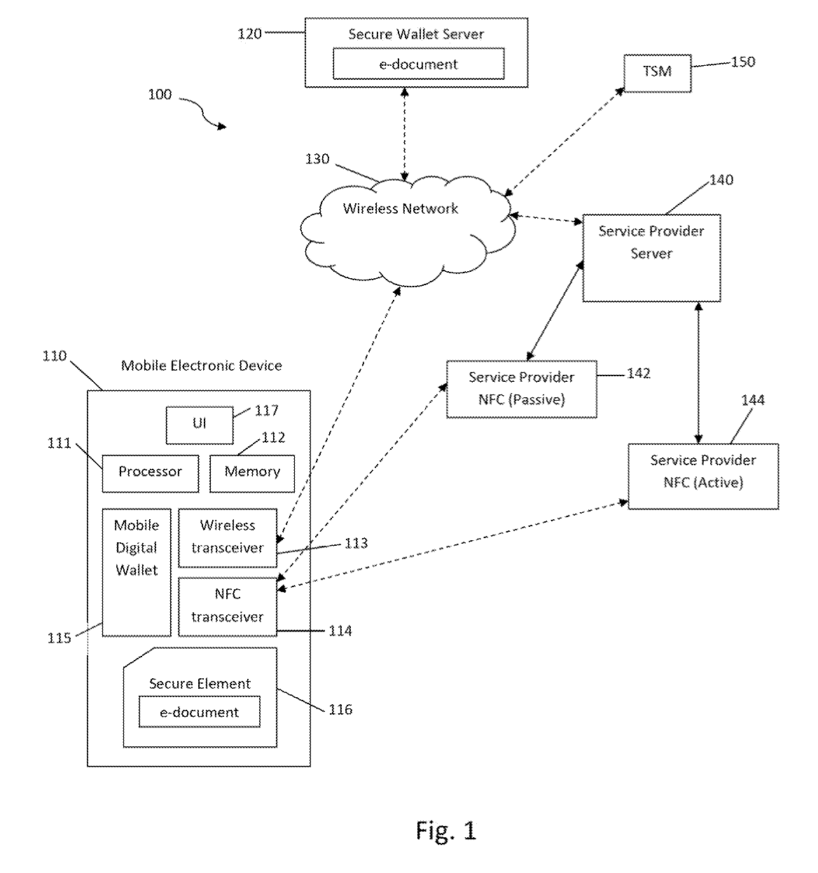

FIG. 1 shows a high-level diagram illustrating an exemplary configuration of a system for providing secure digital identification according to embodiments of the invention. System 100 includes MED 110, secure wallet server 120, wireless network 130, service provider server 140, and Trusted Service Manager (TSM) 150. MED 110 can be a smartphone, PDA, cell phone, multimedia player, tablet, laptop, or any other hand-held device capable of providing a NFC connection. MED 110 can include processor 111, memory 112, wireless transceiver 113, and user NFC transceiver 114. Wireless transceiver 113 can use a wireless protocol such as 3G, LTE, GPRS, Bluetooth, IR, WiFi, or any other wireless communication protocol such that mobile electronic device 110 can communicate with wireless network 130.

In embodiments of the invention, code stored in memory 112 implements a mobile digital wallet 115 in processor 111. Mobile digital wallet 115 is an application which manages access to a user's personal information, as is explained in further detail below. MED 110 also includes secure element 116, which, in embodiments of the present invention, is implemented by a SIM card for a cell phone or a secure memory card, such as a micro-SD card, but which can comprise a variety of read/writeable storage devices. Secure element 116 can be hardware integrated into MED 110, and/or can be a memory card plugged into a memory card slot of MED 110. In some embodiments of the present invention, mobile electronic device 110 can comprise a plurality of secure elements 116. For example, both a SIM card and a memory card can be embedded into a NFC mobile device such as MED 116.

In some embodiments, secure element 116 can be operatively connected to the mobile electronic device 110 as described above. In some embodiments, secure element 116 can be operatively connected to mobile electronic device 110 without being embedded or plugged into the mobile electronic device 20. For example, secure element 116 may be wirelessly connected to mobile electronic device 110 via any appropriate wireless communication means (e.g., Bluetooth, WiFi, RF, etc.) Once secure element 116 is operatively connected to mobile electronic device 110 using any of the above means, NFC transactions can be conducted which can provide access to data stored on secure element 116 in accordance with embodiments of the invention.

Mobile electronic device 110 can also include user interface (UI) 117. In some embodiments, UI 117 can be displayed on a touchscreen or other display operatively coupled to an input device (not shown). A user can input information, such as an account identifier and/or an access identifier (e.g. a password, pin-code, or gesture), through UI 117 to enable access to the e-document containing the user's personal identification information, as will be discussed in detail below. In some embodiments, the contents of the e-document can be independently verified and the e-document can be configured so as to be inaccessible without the user first providing an associated account identifier and/or access identifier. Duplicates of the e-document can be stored both in secure element 116 and on secure wallet server 120, each copy acting as a secure backup of the other.

System 100 also includes at least one of an active NFC transceiver 142 and a passive NFC transceiver 144 associated with a service provider, which is operatively connected to service provider server 140, and which can communicate with user NFC transceiver 114 of mobile electronic device 110. Passive and/or active service provider NFC transceivers 142, 144, can be integrated in other mobile devices, tags, or readers, and/or located at a kiosk or other point-of-sale as required. In some embodiments, a SP may use a NFC enabled mobile device or kiosk to communicate directly with wireless network 130 in lieu of accessing wireless network 130 via service provider server 140. Similarly, TSM 150, which can act as a neutral contact point for business and technical connections between Mobile Network Operators, device manufacturers, and/or other entities requiring access to a user's secure element in a NFC transaction, can enable service providers to communicate with the secure element in NFC-enabled handsets in lieu of the service providers communicating directly with mobile electronic device 110. Of course, a trusted service manager may not be required depending on the type of service provider involved in a given NFC transaction.

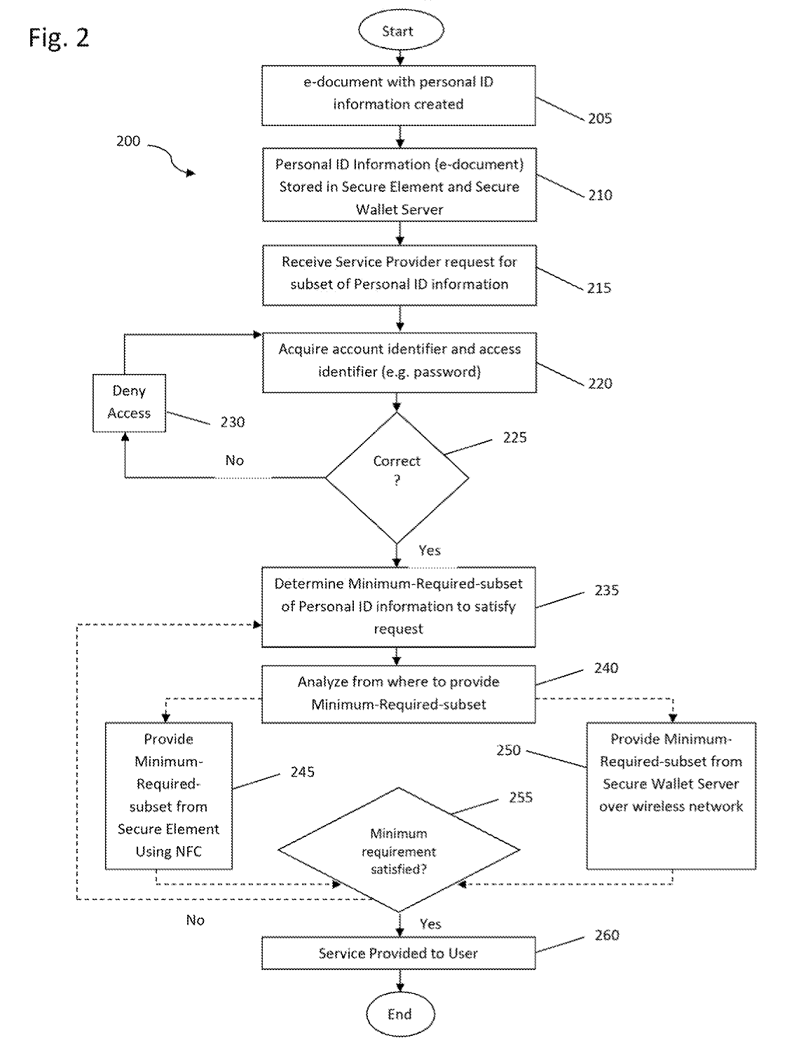

Turning to FIG. 2, a high-level flow diagram illustrating elements of a method for providing secure digital identification according to embodiments of the invention is provided. Method 200, which can be employed, for example, using system 100, starts at step 205 when personal ID information is provided and recorded in a secure e-document. At step 210, the personal ID information (e-document) is stored in secure element 116 and on secure wallet server 120. As explained above, in some embodiments the information in the e-document can be independently verified prior to storage. In some embodiments, the user provides the personal ID information directly to mobile digital wallet 115, which can create the secure e-document. Mobile digital wallet 115 can then store the e-document in secure element 116, and send a copy of the e-document to secure wallet server 120 via wireless network 130 for storage there. In other embodiments, the e-document can be created by the user or a third party via other means, such as through a web portal or web application accessed over the Internet, and the e-document can be uploaded first to secure wallet server 120 using security controls appropriate to maintaining data integrity, as understood by those having ordinary skill in the art. Mobile digital wallet 115 can then download a copy of the e-document via wireless transceiver 113, and store it in secure element 116.

At step 215, mobile digital wallet 115 receives a request from a service provider for access to a subset of the personal ID information recorded in the c-document, in order for the service provider to provide a service to the user. For example, a rental car company may request a user's driver license information prior to renting the user a car, or a liquor store owner may want to verify that a potential alcohol purchaser is above the mandated age restriction. In accordance with embodiments of the invention, a verbal or otherwise non-digital request can be made by a service provider to the user, requesting that the user begin a NFC connection with the service provider. As explained in detail above, this can be an active communication mode connection wherein user NFC transceiver 114 generates a RF field and modulates the field toward SP active NFC transceiver 144, which then replies with a RF field of its own. Alternatively, the NFC connection can be a passive communication mode connection wherein user NFC transceiver 114 generates a RF field and modulates the field toward SP passive NFC transceiver 142, which then responds by modulating the received RF field back to user NFC transceiver 114.

In both of the forgoing embodiments, user NFC transceiver 114 acts as the initiator and either SP passive NFC transceiver 142 or SP active NFC transceiver 144 acts as the target. In some embodiments, while the user is the initiator of the NFC connection, the response received by the user from the target NFC device of the SP can contain the request in digital form. For example, a user can bring MED 110 within the required proximity to a service provider's NFC-enabled device to start an NFC connection, at which time the service provider's NFC-enabled device can digitally request the desired subset of the user's personal ID information from MED 110. In other embodiments, SP active NFC transceiver 144 can act as the initiator, and user NFC transceiver 114 can act as the target. The request from the service provider can then be defined as the transmission of the RF field from SP active NFC transceiver 144 toward user NFC transceiver 114, rather than the request being in response to receiving a transmission from user NFC transceiver 114. In summary, a request from a SP can be in digital form as part of a NFC connection with a user's NFC enabled device, in lieu of a verbal or otherwise non-digital request to begin a NFC connection.

In some embodiments, the access request can comprise a request to connect via NFC, wherein the underlying purpose of the NFC connection is for the SP to receive the user's personal ID information. Furthermore, it should be understood that the access request can additionally or alternatively include a request for the service provider to retrieve the requested information from a predefined location, an unspecified location, and/or a location specified by the SP or user. Alternatively and/or additionally to the request to retrieve information, the access request can include a request for the user to provide the requested information to the SP (i.e., for the SP to receive the requested information) from a predefined location, an unspecified location, and/or a location specified by the SP or user.

In some embodiments, the SP request to initiate a NFC connection can be in the form of an electronic notification (other than an NFC transmission) received at MED 110. For example, an electronic notification can be an e-mail, text message, multimedia message, IM, “tweet”, ping, or any other appropriate form of digital message sent by the SP and received at MED 110 via wireless transceiver 113, requesting a NFC connection with the user. This may be necessary, for example, when user NFC transceiver 114 is not actively enabled for NFC connection, or when an NFC-enabled device of the SP does not detect a RF field of the user.

At step 220, mobile digital wallet 115 acquires an account identifier and/or an access identifier from the user via UI 117. An account identifier may be required, for example, if more than one e-document is stored in secure element 116 and secure wallet server 120, or if more than one profile (set of information) has been created. In this instance, an account identifier can identify the desired e-document or profile. In some embodiments, an account identifier may not be required if there is only one e-document or profile, or if a default e-document or profile has been previously defined. The access identifier may be any form of password, pin-code, or user-defined gesture, etc., typically known only to the user, which can be provided to mobile digital wallet 115 to enable mobile digital wallet 115 to manage access to the user's personal ID information. At step 225, mobile digital wallet 115 verifies the accuracy of the acquired account identifier and/or access identifier. If the inputted account identifier and/or access identifier fails to match a previously defined account identifier and/or access identifier, access is denied at step 230, and the user is again requested to provide the account identifier and/or access identifier. In some embodiments, if an incorrect account identifier and/or access identifier is provided a predefined number of times, an alternative action can be taken, such as a notification being sent to the user, an account manager, and/or the SP indicating, for example, that incorrect information has been provided and access has been denied. If the inputted account identifier and access identifier are correct, then access is granted for the specified account (e-document or profile), and the method continues.

In accordance with embodiments of the invention, at step 235 mobile digital wallet 115 determines, using code executing in the processor, a minimum-required-subset of the set of personal ID information necessary to satisfy the subset of personal ID information requested by the SP. For example, a request may simply ask that user provide identifying information to the SP. There are many types of information that can identify a user, such as a driver license, passport, social security number, etc. In different instances and situations, service providers may require different types of information. For example, to pass a security checkpoint a driver license may be requested, whereas to check in at a hospital a social security card may be requested. Mobile digital wallet 115 can therefore determine a subset of all the personal information stored in the e-document which is sufficient to satisfy the request. To make this determination, mobile digital wallet 115 can, for example, analyze characteristics of the service provider, such as the type of service provided, the location of the service provider, etc.

In some embodiments the subset may require a particular form of identification, or multiple forms of identification, in order to satisfy the request. However, in other embodiments the subset may require less information than is provided by any one particular form of identification, or may require some information from one form of identification and some information from another form of identification. For example, to enter a nightclub with a 21+ age restriction, a driver license may be requested by the nightclub. However, a driver license typically includes a photo of the cardholder, a home address, driver license number, date of birth, hair and eye colors, etc. All the nightclub security actually wants to confirm is whether or not patrons to the nightclub are 21+ years old. However, providing a driver license exposes to strangers more personal information than is necessary to make that confirmation. In such a circumstance, mobile digital wallet 115 can determine which personal information is required, and provide only that information. In this instance, for example, mobile digital wallet 115 can determine that the only information that must be provided from the verified e-document is a date of birth of the patron, and a digital photograph of the patron to confirm the person providing the personal ID information is the same person associated with the personal ID information.

By way of another example, to receive special education services for a child from a school district, a parent may be requested to provide two forms of identification proving the parent resides in that school district. Both a driver license and passport contain the address of the parent, but both also contain other information which the parent may not desire to share, and which are not necessary for proving where the parent lives. Mobile digital wallet 115 can determine which information is required from the two forms of identification, and that subset can be provided to the service provider, in this case the school district, without exposing unnecessary private data.

Once mobile digital wallet 115 determines the minimum-required-subset of personal ID information to provide to the SP, at step 240 mobile digital wallet 115 analyzes, using code executing in the processor, whether to provide the minimum-required-subset of the personal ID information from secure element 116 via user NFC transceiver 114 at step 245, or from secure wallet server 120 via wireless network 130 at step 250. As explained in detail above, the user's personal ID information is stored both in secure element 116 and on secure wallet server 120. Depending on the situation, after receiving the request, mobile digital wallet 115 may determine that it is preferable to provide the information from one source over another. For example, a user at an NFC-enabled airline check-in kiosk may receive a request via the NFC-enabled kiosk in any of the manners described in step 215. Mobile digital wallet 115 can then direct secure wallet server 120 to provide the necessary information directly to the airline's server. In other embodiments, mobile digital wallet 115 can provide the information from secure element 116 to a NFC-enabled device of the service provider via NFC transceiver 114.

At step 255, once the minimum-required-subset of the personal ID information is provided to the service provider, either from secure element 116 via user NFC transceiver 114 or from secure wallet server 120 via wireless network 130, the service provider can confirm that the subset of information provided by mobile digital wallet 115 does in fact satisfy the request. If the provided information fails to satisfy the request, the method can return to step 235, where mobile digital wallet 115 can revise the determined minimum-required-subset. In some embodiments, if mobile digital wallet 115 fails to determine a minimum-required-subset after a predefined number of attempts, an alternative action can be taken, such as a notification being sent to the user, an account manager, and/or the SP, indicating, for example, mobile digital wallet 115 has failed to determine a minimum-required-subset that satisfies the request, and/or indicating that the user should provide the personal ID information manually. If the provided information is sufficient to satisfy the access request, then at step 260 the desired service can be provided to the user and the method ends.

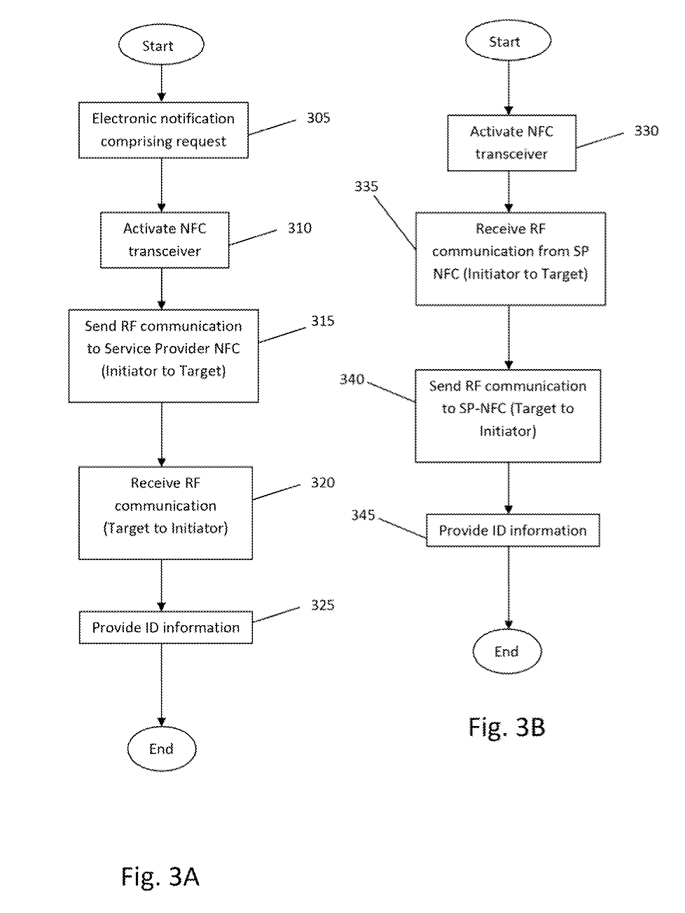

Turning now to FIG. 3A and FIG. 3B, flow diagrams illustrating detailed elements of method 200 of FIG. 2 are provided according to embodiments of the invention. In particular, FIG. 3A and FIG. 3B provide steps that can be taken depending on what roles the user and the SP play in the NFC transaction, initiator or target, in accordance with embodiments of the invention. In the flow diagram of FIG. 3A, MED 110 receives an electronic notification comprising the request at step 305. As explained above, electronic notification can be an e-mail, text message, multimedia message, IM, “tweet,” ping, or any other appropriate form of digital message containing the request. Use of an electronic notification comprising the request can be useful, for example, in situations where user NFC transceiver 114 is not initially activated. As such, the electronic notification can inform the user to activate the NFC feature of MED 110. Alternatively or additionally, the electronic notification can also include other information relating to the request, such as coupons, offers, instructions, directions, etc., in conjunction with the request for personal ID information.

At step 310, mobile digital wallet 115 can activate user NFC transceiver 114, which can then act as initiator and send a RF communication to a NFC-enabled target device of the service provider, such as SP passive NFC transceiver 142 or SP active NFC transceiver 144, at step 315. This can be performed, for example, by waving or tapping MED 110 near or against the SP's NFC-enabled device to prompt the SP to connect via NFC. At step 320, a response from the service provider target is received at user NFC transceiver 114, and then at step 325 personal ID information can be provided in accordance with the further steps of method 200 described in FIG. 2.

In alternative embodiments, as shown in the flow diagram of FIG. 3B, at step 330 mobile digital wallet 115 can activate user NFC transceiver 114 as a target. User NFC transceiver 114 can remain in a target mode until it receives an initiating RF communication via NFC from a NFC-enabled device of a service provider, such as SP active NFC transceiver 144, at step 335. The initiating RF communication can include the request for personal ID information, or simply a request to connect via NFC, with the actual request being sent subsequently during the NFC connection. At step 340, user NFC transceiver 114 responds to the initiator RF communication, and at step 345 personal ID information can be provided in accordance with the further steps of method 200 described in FIG. 2.

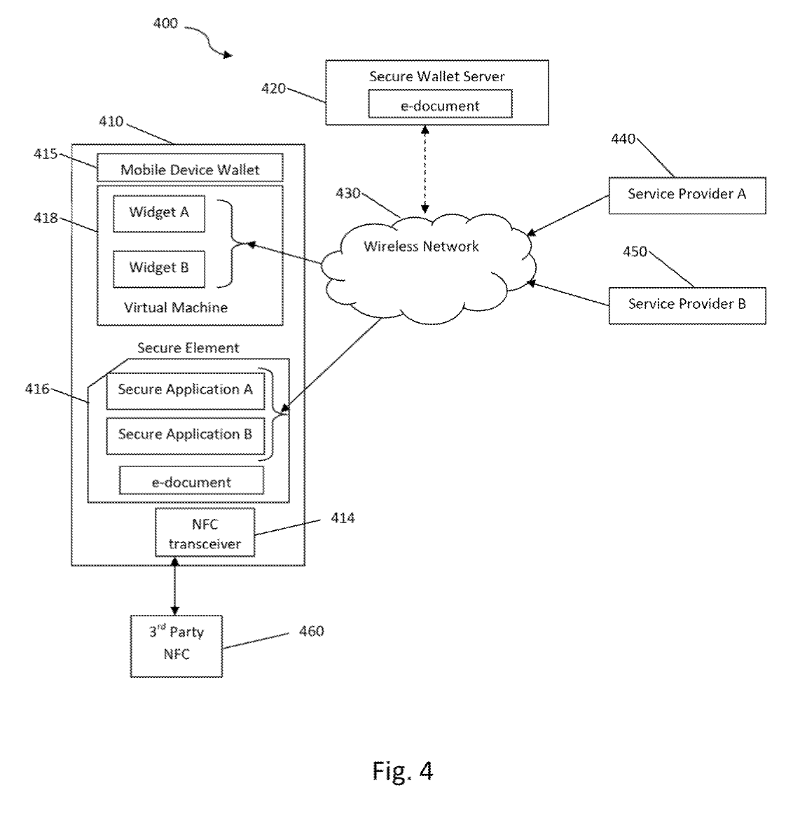

FIG. 4 is a high-level diagram illustrating a further exemplary configuration of a system for providing secure digital identification according to embodiments of the invention. Similar to system 100 of FIG. 1, system 400 includes MED 410, secure wallet server 420, wireless network 430, service provider A server 440, and service provider B server 450. MED 410 can be any hand-held device capable of providing a NFC connection, and can include a processor, memory, wireless transceiver (all not shown), and a user NFC transceiver 414. In embodiments of the invention, code stored in the memory implements in the processor a mobile digital wallet 415. Mobile digital wallet 415 is an application which manages access to a user's personal information, as is explained in further detail below. MED 410 also includes secure element 416, which, in embodiments of the present invention, is implemented by a SIM card for a cell phone or a secure memory card, such as a micro-SD card.

System 400 also includes third-party NFC transceiver 460. Third-party NFC transceiver 460 as described herein can refer to any NFC-enabled device capable of sharing with MED 410 information relating to a service provider via NFC. Third-party NFC transceiver 460 can be part of another user's mobile device, can be a stand-alone kiosk, tag, or reader etc. In some embodiments, third-party NFC transceiver 460 can be owned by or associated with a particular service provider or a plurality of service providers. For example, third-party NFC transceiver 460 can be a NFC-enabled kiosk in a mall or supermarket, etc.

It should be noted that while in the exemplary embodiment of systems 100, 400, one or two server providers are referenced, in other embodiments more or less service providers, and service provider servers, may be included. Furthermore, while in system 400 SP servers are shown in communication with MED 410 and secure wallet server 420 directly over wireless network 430, in other embodiments one or more service provider servers may communicate indirectly via a TSM (not shown). As described above, a service provider can be, for example, a retailer, a financial institution, a transportation system, or a restaurant chain, etc.

Many service providers prefer or require a user to complete a registration or “sign-up” process prior to providing service. The sign-up process can be in relation to a rewards program, membership, account, etc., and typically requires the user to provide at least some personal ID information to the SP. Employing the systems and methods described herein, a streamlined instant sign-up can be achieved. In accordance with embodiments of the invention, a secure application associated with a particular service provider can be provided to the user to be stored in the secure element. Furthermore, a widget lifecycle management platform, and a distribution and transaction system for NFC services, such as is described in detail in U.S. Non-Provisional application Ser. No. 13/934,726 (filed on Jul. 3, 2013 which is hereby incorporated by reference), can be employed to provide service provider widgets to MED 410. Users can access SP widgets on a virtual machine 418 to enable NFC transactions using the associated secure application stored in secure element 416. As will be explained below, mobile digital wallet 415 can play an integral role in the rapid deployment of such systems to MED 410, as well as the other features described herein.

Briefly, as is explained in detail in U.S. Pub. No. US 2011/0143663, published Jun. 16, 2011, in certain embodiments, an integrated distribution and transaction system for at least one mobile electronic device can comprise a server having a widget generator for creating at least one widget having a certificate. A widget is an independent application that is developed using an SDK and that can be run on a virtual machine of the mobile electronic device. The widget may display multimedia content associated with a secure application installed on the mobile electronic device.

In some embodiments, the integrated distribution and transaction system can further include a communication interface for distributing the widget and retrieving widget information associated with NFC transactions, and at least one mobile electronic device having a transaction terminal and a virtual machine. The transaction terminal can include an NFC modem and at least one secure element divided into a plurality of secure domains. The virtual machine can authenticate the certificate, manage the widgets received from the communication interface, and change the widget information, while enabling the mobile electronic device to perform at least one NFC transaction using the corresponding secure application.

According to another broad aspect of the invention that can be used in certain embodiments, a distribution system can be installed on a mobile electronic device, and can be operatively coupled to a secure element having one or more secure applications. In some embodiments, the system can further include a virtual machine configured to execute in a processor to provide a runtime environment capable of running a plurality of widgets. The virtual machine can be configured to enable the widgets to be operable on any of a plurality of mobile operating systems, including the particular mobile operating system on which it is installed. The system can further include a secure element manager configured to enable the widgets to read from or write to the secure element. This can be accomplished, for example, by providing the widgets with access to corresponding secure applications stored in the secure element. The system can enable the mobile electronic device to perform NFC transactions using the corresponding secure applications.

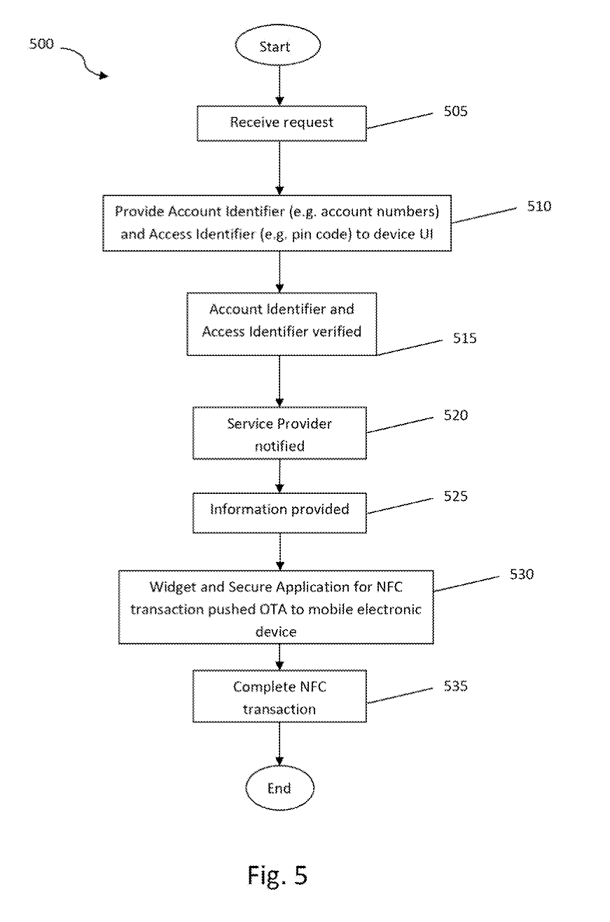

Turning now to FIG. 5, a high-level flow diagram illustrating elements of a further method for providing secure digital identification is provided according to embodiments of the invention. Method 500 starts at step 505 when a request is received by MED 410. As described in detail above, the request can include the request for the user to provide personal ID information that the service provider requires in order to provide a service to the user. For example, a user at a NFC-enabled kiosk in a mall may desire to sign up for a membership card prior to engaging a service provider for services. In this example, a request can be provided via third party NFC transceiver 460, on behalf of the service provider, for the user to provide personal ID information. As another example, while a user is in the process of completing a NFC transaction at a retail store, a request may ask the user if the user would be interested in a rewards program, for which personal ID information must be provided.

At step 510, the user can provide an account identifier and/or an access identifier to mobile digital wallet 415, allowing mobile digital wallet 415 to provide personal ID information recorded in a verified e-document to a service provider in accordance with the methods described herein. At step 515, mobile digital wallet 415 can verify the provided account identifier and/or access identifier, after which the service provider can be notified, at step 520, that the user has been verified. At step 525, the personal ID information can be provided to the service provider by the mobile digital wallet 415. This can include, for example, using one or more of the steps of method 200 outlined in FIG. 2, including determining a minimum-required-subset of the personal ID information required to satisfy the request, analyzing from where to provide the minimum-required-subset to a server of the service provider, and/or sending the information either from secure element 416 via user NFC transceiver 414 or from secure wallet server 420 via wireless network 430.

In accordance with embodiments of the invention, once the user's personal ID information has been provided to the service provider, SP widgets and secure applications for NFC transactions can be pushed over-the-air to MED 410 at step 530 from servers associated with service provider. Finally, at step 535, the user can complete a NFC transaction using the SP widgets and secure application. Thus, employing the systems and methods described herein, a user can quickly and seamlessly complete a sign-up process with a service provider.

At this juncture, it should be noted that although much of the foregoing description has been directed to systems and methods for providing secure digital identification, the systems and methods disclosed herein can be similarly deployed and/or implemented in scenarios, situations, and settings far beyond the referenced scenarios. It is to be understood that like numerals in the drawings represent like elements through the several figures, and that not all components and/or steps described and illustrated with reference to the figures are required for all embodiments or arrangements.

Thus, illustrative embodiments and arrangements of the present systems and methods provide a computer implemented method, computer system, and computer program product for providing secure digital identification. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The functions describe herein can be implemented by hardware and or hardware executing code (also known as programs, software, or software applications) which include machine instructions for a programmable processor, and can be implemented in a high-level procedural and/or object-oriented programming language, and/or in assembly/machine language. As used herein, the terms machine-readable storage medium and computer-readable storage medium refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term machine-readable signal refers to any signal used to provide machine instructions and/or data to a programmable processor. A machine-readable storage medium does not include a machine-readable signal.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet. A wireless network can include both wired and wireless connections.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for providing a mobile digital wallet identification (ID) system for use with a mobile electronic device having a processor, memory, code in the memory for implementing in the processor a mobile digital wallet, and an NFC transceiver, the mobile electronic device being operatively coupled to a secure element and being in wireless communication with a secure wallet server over at least one wireless network, the method comprising:
receiving at the mobile digital wallet a service provider request which requests access to a subset of a set of personal ID information to enable the service provider to provide a service, the set of personal ID information being stored both in the secure element and at the secure wallet server;
determining by the mobile digital wallet, using code executing in the processor, a minimum-required-subset of the set of personal ID information necessary to satisfy the access request to the requested subset of the set of personal ID information;
analyzing, by the mobile digital wallet, using code executing in the processor, whether to provide the minimum-required-subset of the personal ID information from the secure element via the NFC transceiver or from the secure wallet server via the wireless network; and
causing the minimum-required-subset of the set of personal ID information to be provided to the service provider in response to the analyzing step having concluded to provide the minimum-required-subset of the set of personal ID information.

2. The method of claim 1, further comprising, initializing a wireless download of at least one of a widget and a secure application over the wireless network from a server of the service provider subsequent to the service provider receiving the minimum-required-subset of the set of personal ID information as a result of the causing step.

3. The method of claim 1, further comprising, prior to the causing step, acquiring by the mobile digital wallet an account identifier and an access identifier from the user, the account identifier being associated with an account comprising the set of personal ID information and the access identifier indicating a right of the user to access the account.

4. The method of claim 3, wherein the access identifier is at least one of a numeric code, an alphabetical code, an alphanumeric code, and a gesture, and wherein the access identifier is acquired via a User Interface (UI) of the mobile electronic device and detected by the mobile digital wallet.

5. The method of claim 1, wherein the service provider request is an initiator request generated by a service provider-NFC transceiver, and wherein the mobile electronic device is a target of the initiator request.

6. The method of claim 1, wherein the service provider request is a response generated by a target service provider-NFC transceiver in response to an initiator request sent from the NFC transceiver of the mobile electronic device.

7. The method of claim 1, further comprising activating the NFC transceiver for radio frequency (RF) communication prior to the receiving step, enabling the receiving of the service provider request.

8. The method of claim 1, the receiving step further comprising receiving at the mobile digital wallet an electronic notification comprising the service provider request.

9. The method of claim 8, wherein the electronic notification is one of a text message, multimedia message, instant message, and e-mail, notifying the user of a desire of the service provider to access the subset of the set of personal ID information.

10. The method of claim 1, wherein the set of personal ID information includes at least one of the user's government-issued ID information, identifying image, biometric data, secure login credentials, membership information, address, and contact information.

11. A mobile digital wallet identification (ID) system comprising:
a mobile electronic device having a processor, memory, code in the memory for implementing in the processor a mobile digital wallet, and an NFC transceiver;
a secure element, the mobile electronic device being operatively coupled to the secure element; and
a secure wallet server, the mobile electronic device being in wireless communication with the secure wallet server over at least one wireless network;
wherein the code in the memory for implementing in the processor the mobile digital wallet is executable in the processor of the mobile electronic device which, when executed, configures the processor to:
receive at the mobile digital wallet a service provider request which requests access to a subset of a set of personal ID information to enable the service provider to provide a service, the set of personal ID information being stored both in the secure element and at the secure wallet server;
determine by the mobile digital wallet, using code executing in the processor, a minimum-required-subset of the set of personal ID information necessary to satisfy the access request to the requested subset of the set of personal ID information;
analyze, by the mobile digital wallet, using code executing in the processor, whether to provide the minimum-required-subset of the personal ID information from the secure element via the NFC transceiver or from the secure wallet server via the wireless network; and
cause the minimum-required-subset of the set of personal ID information to be provided to the service provider in response to the analyzing step having concluded to provide the minimum-required-subset of the set of personal ID.

12. The system of claim 11, further configured to initialize a wireless download of at least one of a widget and a secure application over the wireless network from a server of the service provider subsequent to the service provider receiving the minimum-required-subset of the set of personal ID information as a result of the causing operation.

13. The system of claim 11, the processor further configured to acquire by the mobile digital wallet, prior to the causing operation, an account identifier and an access identifier from the user, the account identifier being associated with an account comprising the set of personal ID information and the access identifier indicating a right of the user to access the account.

14. The system of claim 13, wherein the access identifier is at least one of a numeric code, an alphabetical code, an alphanumeric code, and a gesture, and wherein the access identifier is acquired via a User Interface (UI) of the mobile electronic device and detected by the mobile digital wallet.

15. The system of claim 11, wherein the service provider request is an initiator request generated by a service provider-NFC transceiver, and wherein the mobile electronic device is a target of the initiator request.

16. The system of claim 11, wherein the service provider request is a response generated by a target service provider-NFC transceiver in response to an initiator request sent from the NFC transceiver of the mobile electronic device.

17. The system of claim 11, further configured to activate the NFC transceiver for radio frequency (RF) communication prior to the receiving step, enabling the receiving of the service provider request.

18. The system of claim 11, the processor further configured to receive at the mobile digital wallet an electronic notification comprising the service provider request.

19. The system of claim 18, wherein the electronic notification is one of a text message, multimedia message, instant message, and e-mail, notifying the user of a desire of the service provider to access the subset of the set of personal ID information.

20. The system of claim 1, wherein the set of personal ID information includes at least one of the user's government-issued ID information, identifying image, biometric data, secure login credentials, membership information, address, and contact information.
